(19) United States
(12) Patent Application Publication
(10) Pub. No.: US 2014/0017915 A1
(43) Pub. Date: Jan. 16, 2014

(54) ELECTRICAL GROUNDING SYSTEM FOR LINEARLY TRAVELLING CONDUCTIVE MATERIALS

(71) Applicants: Cap Technologies, LLC, Baton Rouge, LA (US); Honeybee Robotics Ltd., New York, NY (US)

(72) Inventors: Ron Hayes, Longmont, CO (US); Lee Carlson, New York, NY (US); Mateusz Szczesiak, Rego Park, NY (US); Jason Herman, East Northport, NY (US); Edward Daigle, Covington, LA (US)

(73) Assignees: CAP Technologies, LLC, Baton Rouge, LA (US); HONEYBEE ROBOTICS LTD., NEW YORK, NY (US)

(21) Appl. No.: 13/941,321

(22) Filed: Jul. 12, 2013

Related U.S. Application Data
(60) Provisional application No. 61/670,833, filed on Jul. 12, 2012.

(51) Int. Cl. H01R 13/648

(52) U.S. Cl. CPC H01R 13/648
USPC 439/95

(57) ABSTRACT

An electrical grounding system has a frame containing one or more line component subassemblies supporting multiple lines of conductive material traveling linearly in parallel in a horizontal direction, and one or more preload subassemblies positioned in a vertical direction above the respective line component subassemblies. The line component subassembly has an array of grounding contact rollers positioned below and supporting the respective lines of conductive material traveling in electrical contact thereon. The preload subassembly has an array of preload rollers positioned above and applying a preload force to the respective lines of conductive material in electrical contact with the rollers of the line component subassembly below.

This U.S. patent application claims the priority filing date of U.S. Provisional Application 61/670833 filed Jul. 12, 2012, of the same title and by the same inventors as in the present application.

The subject matter of this U.S. patent application was developed pursuant to a joint research agreement between the applicant hereof and CAP Technologies, LLC, Baton Rouge, La., that was in effect on or before the effective filing date of the claimed invention, and was made as a result of activities undertaken within the scope of the joint research agreement, pursuant to 35 U.S.C. 102(c), as amended by Section 3 of the Leahy-Smith America Invents Act (AIA), in conjunction with the Cooperative Research and Technology Enhancement Act of 2004 (“CREATE Act”), Public Law 108-453, 118 Stat. 3596 (2004).

### BACKGROUND

In the fabrication of metal-coated materials, it is desirable to produce coated wires, cables, rods, etc., by applying an electrical current to a conductive substrate material in the presence of conductive coating material so as to form an electro-chemical bond between substrate and coating. For example, in the field of electro-plasma technology (EPT), an advanced electro-coating technique applies D.C. potential between two electrodes in an aqueous media, producing discreet bubbles in which plasma is formed near the surface of the work piece. The plasma forms evenly across the surface of the work piece, providing a number of unique processing advantages. When the plasma bubble implodes, it produces shock waves that assist in removing surface contaminants and micro-modify the metal surface, removing oxide scale, lubricants, dirt, etc. As oxide mill scale is removed, the resulting surface is passivated against corrosion due to reconstituting of a portion of the scale into alpha iron. This provides excellent adhesion properties and allows metal and alloy coatings to be deposited.

For the advanced EPT technique, it is important that the processing of metal substrate material can run continuously at relatively high speeds, while also providing for improvement in quality and cost. The advanced EPT technique has significant advantages over conventional techniques such as hot-dip galvanizing and electroplating, as it has shown higher deposition rates and superior adhesion at lower power consumption, which translates to higher quality at lower cost, and can be used to both clean and coat a substrate whereas the conventional processes only do one or the other. EPT reactors can also be strung in series to continuously clean then coat the target metal, thereby providing a significant efficiency improvement and reducing time and cost between operations.

EPT processing lines can also be operated in parallel to process multiple lines at the same time. For multiple line operation, it is desirable to provide continuous electrical contact of a fixed grounding station with multiple conductive substrate lines such as wire rods being pulled in a linearly traveling fashion. The conductive components may be traveling at linear speeds that vary relative to one another. In addition, the conductive components may not be perfectly straight and may require a preload force to be applied on the line to maintain sufficient electrical contact with the grounding station. The grounding station should also be able to accommodate conductive components that may all be of the same diameter or may vary in diameter.

In conventional grounding systems, electrical pick-up shoes are typically used to provide continuity for linearly traveling lines, such as shoes that maintain contact with a powered third rail for a railroad train. Conventional contact shoe designs use simple spring-loaded, conductive brushes that slide on the contacting surface to provide a conductive pathway. However, these spring-loaded, conductive brushes require a uniform component to create a low-resistance electrical pathway and do not tolerate variations in contact geometries well. Simple brushes may deposit brush material on the contacting surface, affecting processes that rely on target surface properties. Simple brushes also require carefully engineered material combinations and surface qualities for a high-performance, long-life design.

### SUMMARY OF INVENTION

It is therefore a principal object of the present invention to provide an electrical grounding system that can reliably and stably maintain electrical contact with multiple lines of linearly traveling materials in parallel. A particular object is to provide continuous electrical contact where the conductive component lines may be traveling at linear speeds that vary relative to one another, may not be perfectly straight, and may vary in diameter.

In accordance with the present invention, an electrical grounding system comprises a frame containing one or more stations of a line component subassembly having multiple lines of conductive material traveling linearly in parallel in a horizontal direction spaced apart in a transverse direction from each other, and one or more stations of a preload subassembly positioned in a vertical direction above each respective line component subassembly, wherein each said line component subassembly has an array of multiple grounding contact rollers spaced apart in a transverse direction from each other and positioned below and supporting respective lines of conductive material traveling linearly in electrical contact thereon, and wherein each said preload subassembly has an array of multiple preload rollers spaced apart in a transverse direction from each other and positioned above and applying a preload force to respective lines of conductive material traveling linearly in electrical contact with respective grounding contact rollers of said line component subassembly below.

Preferably, the grounding contact rollers of the line subassembly are each supported by a bearing to allow for relative rotation to be free-wheeling and independent of adjacent grounding contact rollers, enabling each line to translate at a variable linear speed. The conductive brush contact surface on each roller has a spring-loaded cantilevered conductive brush in contact with it to provide an electrical pathway from the line component to the conductive brush and via a wire lead to a shunt to a fixed ground point. The conductive brushes are spring-loaded via the cantilever spring and connected to the shunt to allow a low electrical resistive pathway to ground. Each grounding contact roller has an isolated ground path that is routed back to an electrical enclosure where resistive elements may be added to adjust ground path resistances.

Preferably, the preload rollers of the preload subassembly are each formed by a dielectric preload roller mounted on a cantilever spring to apply a predetermined range of preload force on the respective line so that it can maintain good electrical contact with the respective grounding contact roller of the line component subassembly. The cantilever springs are designed such that the lines of linearly traveling conductive material can vary in diameter without disrupting the fidelity of the electrical contact. A mechanism for vertical adjustment is provided to adjust the vertical positioning of the preload assembly for the preload wheels to apply the predetermined range of preload force on the respective lines. Preferably, the mechanism for vertical adjustment is formed by a leadscrew that moves a unibody structure up and down. The preload assembly with its dielectric preload wheels on cantilever springs are all attached to this structure. The cantilever springs are designed so that at a given vertical adjustment position of the structure, a sufficient preload force is applied to accommodate a range of varying line diameters. This preload adjustment technique can be used for different types of conductive material lines, such as wire rod, flat bar, and plate stock.

The electrical grounding station can have a plurality of stations of line subassemblies and a plurality of stations of preload subassemblies to allow for current-sharing along multiple pathways in order to reduce the likelihood of a broken ground path should an individual grounding contact roller fail in some manner.

Other objects, features, and advantages of the present invention will be explained in the following detailed description of the invention having reference to the appended drawings.

### BRIEF DESCRIPTION OF DRAWINGS

FIG. 1 illustrates an overview of a preferred embodiment of an electrical grounding system for multiple lines of linearly traveling, steel wire rods.

FIGS. 2A, 2B, and 2C show plan, side and end views of the preferred embodiment of electrical grounding system for multiple lines of steel wire rods.

FIGS. 3A and 3B show side and end detailed views of the preload and line subassemblies.

FIG. 4 shows a detailed view of the grounding contacts of the line subassembly.

FIG. 5 illustrates the electrical enclosure for terminating the shaft subassemblies and preload subassemblies in electrical connection to a main grounding terminal.

### DESCRIPTION OF PREFERRED EMBODIMENTS

In the following detailed description of the invention, certain preferred embodiments are illustrated providing certain specific details of their implementation. In particular, an electrical grounding system is described for maintaining good grounding contact with multiple component lines of linearly traveling steel wire rod. However, it will be recognized that the principles described herein may be applied equivalently to other types of linearly traveling conductive materials and other configurations for the constituent subassemblies, and that many other variations and modifications may be made by one of ordinary skill in this field of art given the disclosed principles of the invention.

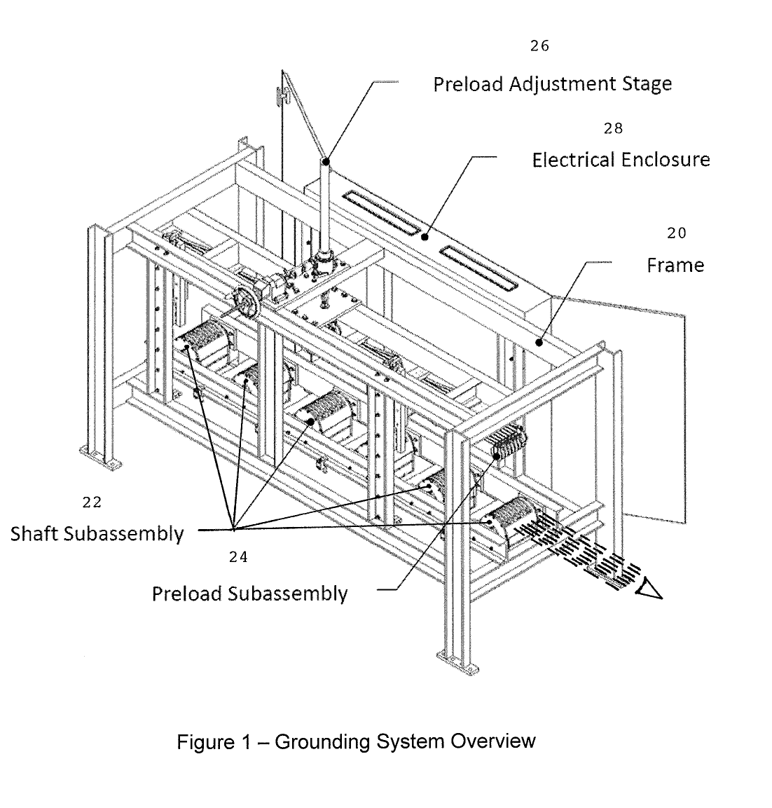

FIG. 1 illustrates an overview of a preferred embodiment of an electrical grounding system for multiple lines of linearly traveling, steel wire rods. The system comprises a frame 20 containing one or more stations of a line component subassembly, indicated as shaft subassembly 22, for supporting multiple lines of conductive material traveling linearly in parallel in a horizontal direction spaced apart in a transverse direction from each other (indicated by the dashed lines in the figure). One or more stations of a preload subassembly 24 are positioned in a vertical direction above each respective line component subassembly 22. A preload adjustment stage 26 is provided to adjust the vertical positioning of the preload assembly to apply the desired preload force on the lines of steel wire rods in grounding contact with grounding contact rollers of the shaft subassembly 22. An electrical enclosure 28 is provided for wiring the ground contact leads from the shaft subassembly(ies) 22 to a main ground terminal for the system. The plurality of stations of line subassemblies and preload subassemblies allow for current-sharing along multiple pathways in order to reduce the likelihood of a broken ground path should an individual grounding contact roller fail in some manner.

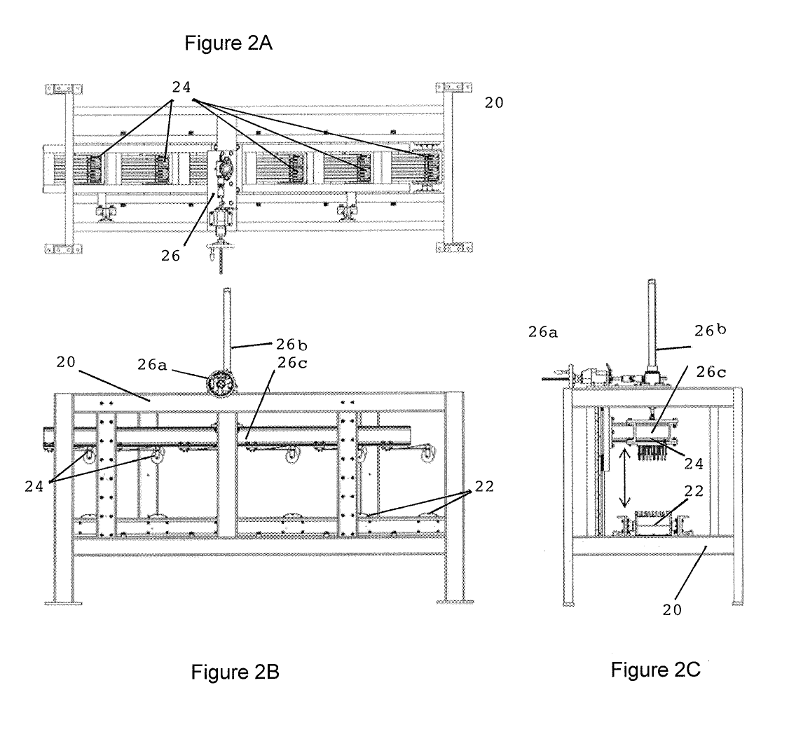

FIGS. 2A, 2B, and 2C show plan, side and end views of the preferred embodiment of electrical grounding system having frame 20, shaft subassemblies 22, preload subassemblies 24, and preload adjustment stage 26 (the electrical enclosure is not shown in the figure). Preferably, the preload adjustment stage 26 is formed by a leadscrew 26a that moves a plunger 26b to adjust the positioning of a unibody structure 26c up and down. The preload assembly 24 with its dielectric preload wheels on cantilever springs are all attached to this structure 26c. This preload adjustment technique can be used for different types of conductive material lines, such as wire rod, flat bar, and plate stock.

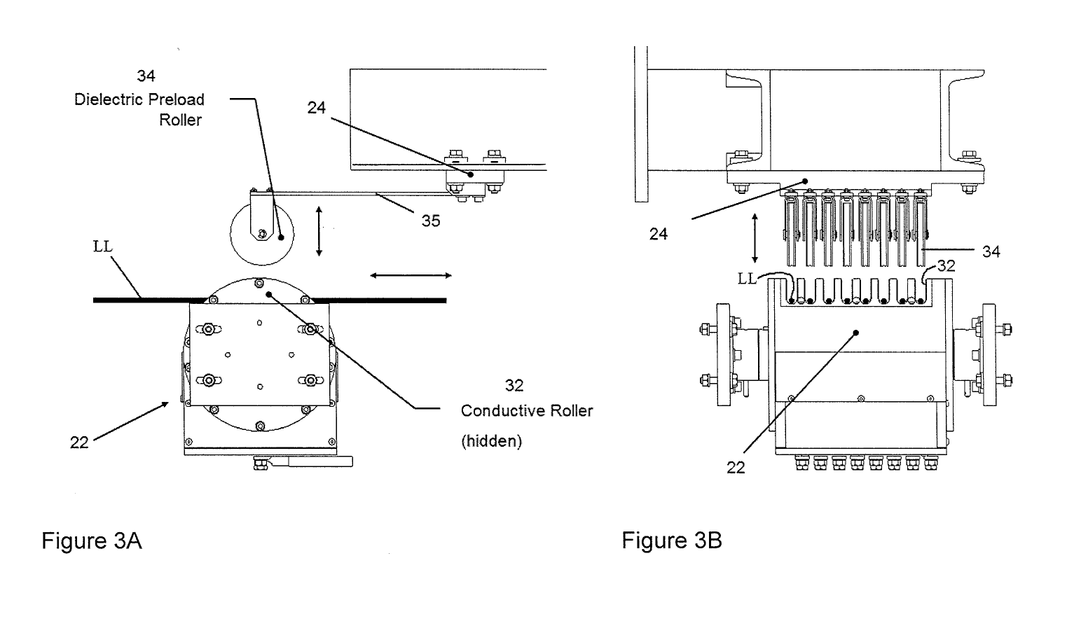

FIGS. 3A and 3B show side and end detailed views of the preload and line subassemblies. The shaft subassembly 22 has an array of grounding contact (conductive) rollers 32 spaced apart in a transverse direction from each other and positioned below and supporting respective lines LL of steel wire rod thereon. The preload subassembly 24 has an array of dielectric preload rollers 34 spaced apart in a transverse direction from each other and positioned above and applying a preload force to the respective lines LL of steel wire rod. Each dielectric preload roller 34 is mounted on a cantilever spring 35 to apply a predetermined range of preload force on the lines LL against the conductive rollers 32 of the shaft subassembly 22 below. The cantilever springs are designed such that the lines of linearly traveling conductive material can vary in diameter without disrupting the fidelity of the electrical contact.

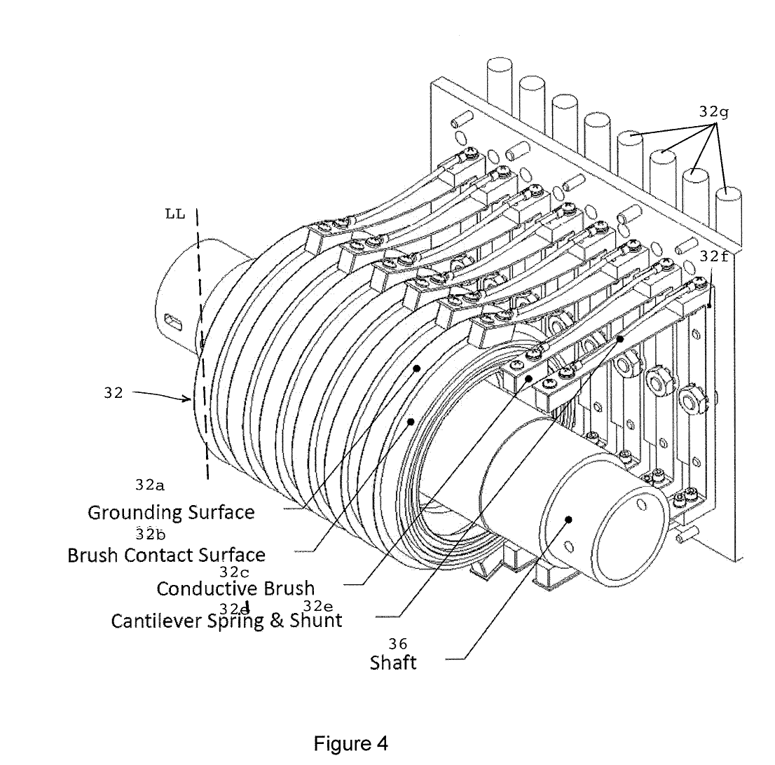

FIG. 4 shows a detailed view of the grounding contacts of the shaft subassembly. Each shaft subassembly has an array of conductive rollers 32 each having a grounding surface 32a that makes grounding contact with a respective line LL of steel wire rod. The conductive roller 32 is in conductive contact with a respective brush contact surface 32b, which is contacted by a conductive brush 32c supported on a cantilever spring 32d and electrically connected by a shunt wire 32e to a grounding post 32f. The conductive brushes 32c are spring-loaded via the cantilever spring 32d and connected to the shunt to allow a low electrical resistive pathway to ground. The grounding post 32f is electrically connected by a respective bus bar 32g to a main ground terminal in the electrical enclosure (reference 28 in FIG. 1). Each conductive roller 32 is supported by a bearing on a shaft 36 so that it is free-wheeling and can rotate relative to its adjacent conductive rollers, thereby enabling each line LL to translate at the same or different linear speed.

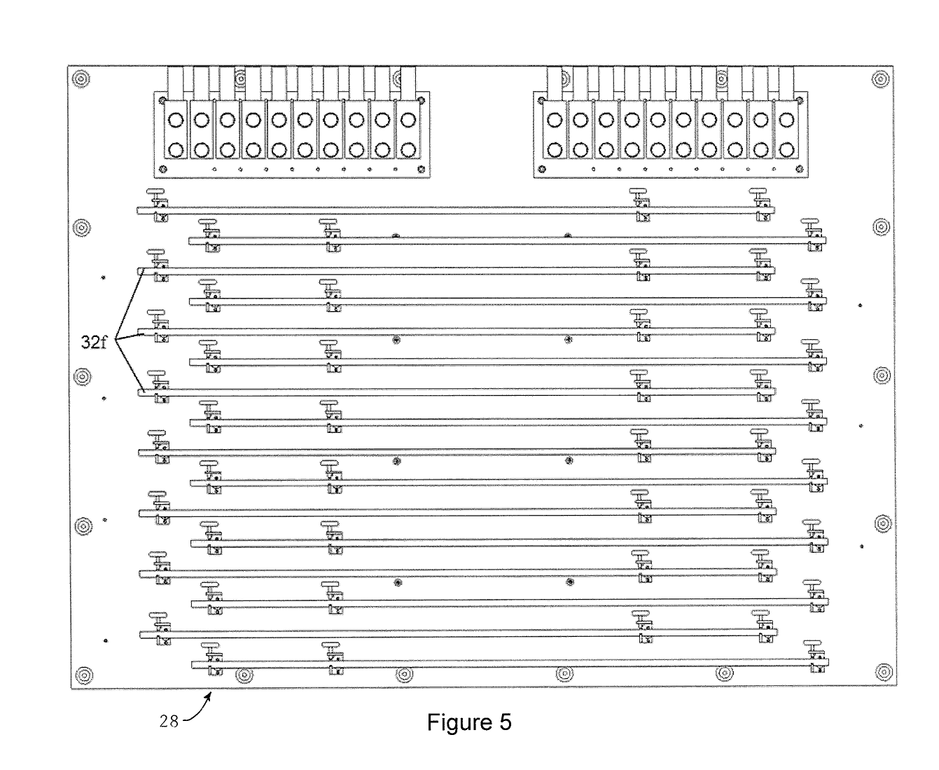

FIG. 5 illustrates the electrical enclosure 28 for terminating the ground contact bus bars 32f from the shaft subassemblies and from the preload subassemblies in electrical connection to a main grounding terminal, and allowing for resistive elements to be configured to allow current equalizing between multiple ground paths.

The above-described exemplary embodiment of the electrical grounding system has been designed particularly for handling steel wire rod. However, the system may be designed with other configurations for other line geometries and conductive materials, such as rectangular aluminum tubing. The number of shaft subassemblies and/or conductive rollers can be selected based on the specific application requirements. The conductive roller material, geometry, and brush material can be selected based on the specific application requirements.

The electrical grounding system as described herein allows for a range of material geometries, sizes, and surface conditions to be grounded which maintaining a long-life system. Having a plurality of stations of shaft assemblies allows for current sharing as well as the ability for one or more rollers to lose grounding contact without complete loss of continuity. This helps to reduce sparking which may also have an adverse effect on material properties and lead to increased roller wear. The electrical grounding system of the invention enable independently arranged conductive rollers to accommodate an array of linearly travelling wire rods, each moving at varying speed and/or having varying diameters. Plural stations of shaft subassemblies enable current sharing and increase system conductivity in the presence of non-uniformities in the wire rod. The invention is deemed to encompass the related method of grounding multiple lines of rod, flat stock, or other linearly moving materials in this fashion.

It is to be understood that many modifications and variations may be devised given the above description of the general principles of the invention. It is intended that all such modifications and variations be considered as within the spirit and scope of this invention, as defined in the following claims.

1. An electrical grounding system comprising:
a frame containing one or more stations of a line component subassembly having multiple lines of conductive material traveling linearly in parallel in a horizontal direction spaced apart in a transverse direction from each other, and one or more stations of a preload subassembly positioned in a vertical direction above each respective line component subassembly,
wherein each said line component subassembly has an array of multiple grounding contact rollers spaced apart in a transverse direction from each other and positioned below and supporting respective lines of conductive material traveling linearly in electrical contact thereon, and
wherein each said preload subassembly has an array of multiple preload rollers spaced apart in a transverse direction from each other and positioned above and applying a preload force to respective lines of conductive material traveling linearly in electrical contact with respective grounding contact rollers of said line component subassembly below.

2. An electrical grounding system according to claim 1, wherein the grounding contact rollers of the line subassembly are each supported by a bearing to allow for relative rotation to be free-wheeling and independent of adjacent grounding contact rollers, thereby enabling each line to translate at a variable linear speed.

3. An electrical grounding system according to claim 2, wherein each grounding contact roller has a conductive brush contact surface on each roller with a conductive brush in contact with it to provide an electrical pathway from the line component to a fixed ground terminal.

4. An electrical grounding system according to claim 3, wherein each conductive brush in contact with a respective grounding contact roller is mounted by a cantilever spring and has a wire lead for a shunt to connect with the fixed ground terminal.

5. An electrical grounding system according to claim 1, wherein the preload rollers of the preload subassembly are each formed by a dielectric preload roller mounted on a cantilever spring to apply a predetermined range of preload force on the respective line so that it can maintain good electrical contact with the respective grounding contact roller of the line component subassembly.

6. An electrical grounding system according to claim 1, further comprising a mechanism for vertical adjustment of positioning of the preload subassembly for the preload rollers to apply the predetermined range of preload force on the respective lines.

7. An electrical grounding system according to claim 6, wherein the mechanism for vertical adjustment is formed by a leadscrew that moves a unibody structure up and down, and the preload subassembly with its preload rollers are mounted to the unibody structure.

8. An electrical grounding system according to claim 1, wherein the lines of conductive material are one of different types of conductive material lines consisting of wire rod, flat bar, and plate stock.

9. An electrical grounding system according to claim 1, further comprising a plurality of stations of line subassemblies and a plurality of stations of preload subassemblies to allow for current-sharing along multiple pathways in order to reduce the likelihood of a broken ground path.

10. An electrical grounding system according to claim 1, further comprising an electrical enclosure for connecting grounding contacts from the line subassembly to a fixed grounding terminal.
